(19) United States
(12) Patent Application Publication
(10) Pub. No.: US 2002/0043258 A1
(43) Pub. Date: Apr. 18, 2002

(54) Portable outdoor barbeque grill

(76) Inventor: Louie Sainz, Sun Valley, CA (US)

Correspondence Address: Kendal M. Sheets, Zito tlp, Suite 203, 26005 Ridge Road, Damascus, MD, 20872, US

(21) Appl. No.: 09/960,604

(22) Filed: Sep. 21, 2001

Related U.S. Application Data
(60) Provisional application No. 60/234,234, filed on Sep. 21, 2000.

(51) Int. Cl. A47J 37/00

(52) U.S. Cl. 126/9 R; 126/25 R

(57) ABSTRACT

The portable barbeque unit has a smaller footprint than typical grills. This is a barbequing apparatus housed by a a clay bowl or pot, such as a terra cotta flower pot. The grill is designed to take advantage of the properties of the smaller volume and heat-resistant qualities of clay-fired pottery as the base for the unit. The base is naturally heat-resistant to deformation and retains and transfers thermal energy from a heat source back into unit, thereby maintaining the temperature of the headspace in the unit for a longer period of time compared to typical barbeque grills. The compact space within the barbeque allows charcoal briquettes to bum hot for hours, creating a longer burning time and an economical utilization of charcoal.

### PRIORITY APPLICATION

This application claims the priority of provisional application No. 60/234,234 PORTABLE OUTDOOR BARBEQUE GRILL by Louie Sainz, filed Sep. 21, 2000.

### BACKGROUND

The popularity of outdoor cooking increases each year, especially with respect to those cooking devices that are portable and easy to use. The present invention generally relates to portable cookers, or grills, that may be used outdoors utilizing charcoal briquettes. An alternative embodiment is a portable cooker that uses a heating element to warm or cook food inside of a container on the grill surface. Prior art grills, while becoming smaller, have larger grilling areas and still require a large footprint for a grilling area. A need exists for a small, compact grill capable of multiple uses to charcoal or to warm food over a continuous heat source.

### SUMMARY OF THE INVENTION

The portable barbeque unit has a smaller footprint than typical grills. This is a barbequing apparatus housed by a a clay bowl or pot, such as a terra cotta flower pot. The grill is designed to take advantage of the properties of the smaller volume and heat-resistant qualities of clay-fired pottery as the base for the unit. The base is naturally heat-resistant to deformation and retains and transfers thermal energy from a heat source back into unit, thereby maintaining the temperature of the headspace in the unit for a longer period of time compared to typical barbeque grills. The barbeque grill of the preferred embodiment brings this desirable method of cooking into a portable barbeque unit. The compact space within the barbeque allows charcoal briquettes to burn hot for hours, creating a longer burning time and an economical utilization of charcoal. Due to the increased concentration of heat into a smaller area, and the heat transfer ability of a clay-fired pottery, food on top of the grill can cook faster as well. The grill is useful for heating food quickly if full cooking is not desired. The small footprint and light weight of the unit allows portability. The preferred embodiment is sized to grill, for example, three shishkabobs or three hot dogs contemporaneously. This makes the portable grill easy to carry to picnics, sporting events, or any gathering without having to transport a large grilling apparatus and large bags of charcoal.

The portable barbeque grill is advantageous to cleanup after grilling over the prior art. A common problem with barbeque grills is cleaning grease drips and food spills off of the grill grate and the components of the barbeque unit underneath the grate. Grease drips and food spills into the internal bottom surface of the preferred embodiment fall onto charcoal briquettes and are either burned off or mix with the ash created after briquettes have burned. After cooking and grilling activities are completed, the ash and residual drips may be removed from the unit by removing the grill grate, inverting the unit, thereby allowing ash to evacuate the unit by gravity into a waste container. The residual ash may also be utilized as fertilizer and disposed of over flowerbeds, shrubbery, or compost piles, thereby enhancing the environment by creating less solid waste disposed to a landfill.

The barbeque unit of the preferred embodiment is constructed of fired clay materials, which makes the unit susceptible to breakage if dropped or compressed. An alternative exemplary embodiment, illustrated in FIG. 4, adds an external base to the clay base of the grill unit. The external base may be constructed of material having high insulation properties and high tensile strength to prevent heat from escaping the unit while providing enhanced structural strength. As a further alternative, insulating and impact-resistant materials may be added between the clay base and structural base to add insulating properties and impact resistance to the grill unit.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is a side view of a portable barbeque grill according to the preferred embodiment.

FIG. 2 is side view into the lid of the portable barbeque grill.

FIG. 3 is a plan view of the grill grate of the portable barbeque unit.

FIG. 4 is a side view of an alternative embodiment of a lower container section of the preferred embodiment.

FIG. 5 is a side view of an alternative embodiment of a lid section of the preferred embodiment.

FIG. 6 is a top view of the an alternative embodiment of a lower container section containing the grill component.

### DETAILED DESCRIPTION OF PREFERRED EXEMPLARY EMBODIMENTS

The present invention comprises a portable grill apparatus. This is a barbequing apparatus housed by a a clay bowl or pot, such as a terra cotta flower pot, that is designed to take advantage of the properties of the smaller volume and heat-resistant qualities of clay-fired pottery as the base for the unit. Materials of construction are naturally heat-resistant to deformation and retains and transfers thermal energy from a heat source back into unit, thereby maintaining the temperature of the headspace in the unit for a longer period of time compared to typical barbeque grills. The barbeque grill of the preferred embodiment brings this desirable method of cooking into a portable barbeque unit. The compact space within the barbeque allows charcoal briquettes to burn hot for hours, creating a longer burning time and an economical utilization of charcoal. Due to the increased concentration of heat into a smaller area, and the heat transfer ability of a clay-fired pottery, food on top of the grill can cook faster as well.

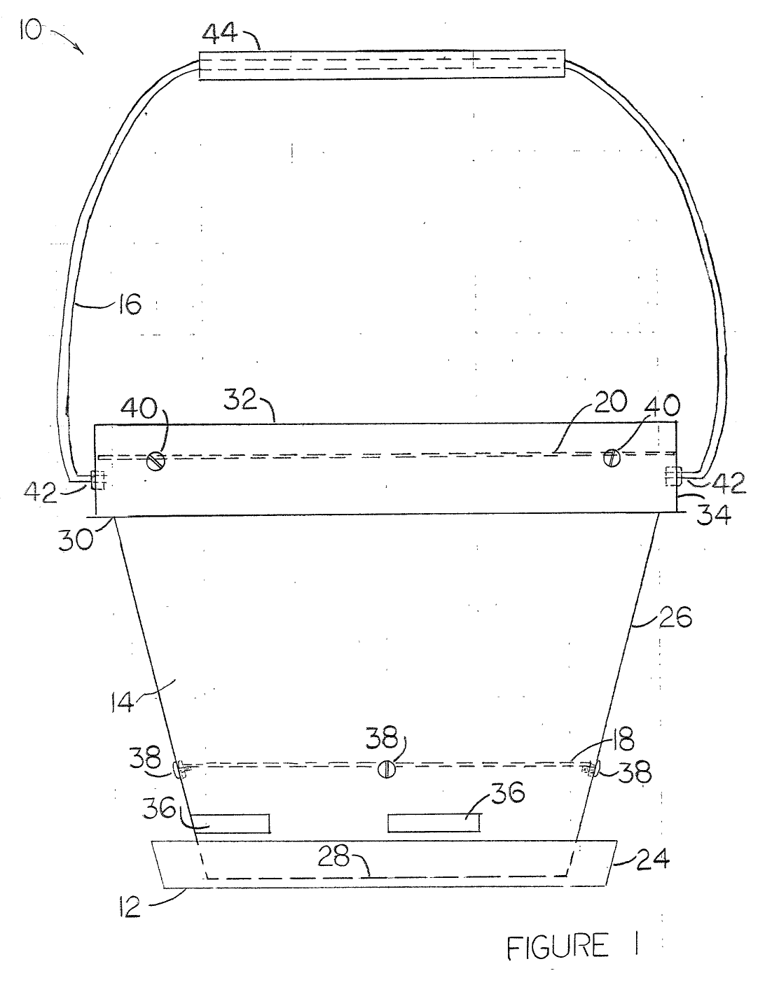

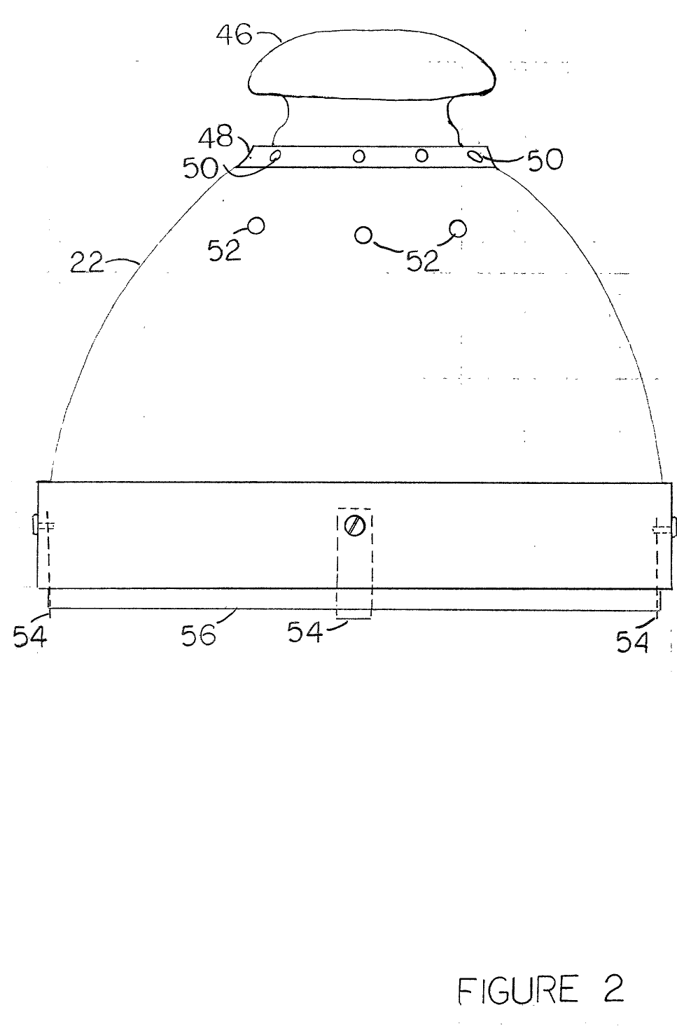

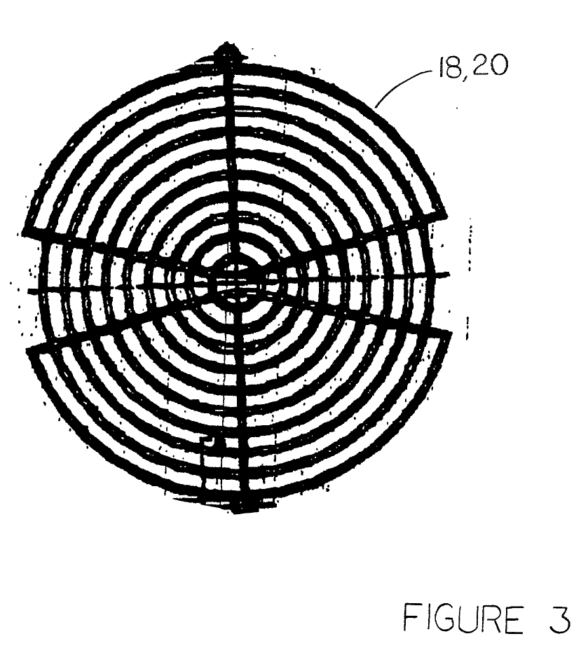

Reference is made to FIG. 1, illustrating the preferred embodiment of the portable outdoor barbeque grill 10. The grill comprises a circular stabilizer plate 12, a circular base 14 shaped as a pot, a handle 16, a first lower grill grate 18, a second upper grill grate 20. FIG. 2 illustrates the lid 22 for the grill and FIG. 3 illustrates an exemplary grill grate design as used for upper 20 and lower 18 grill grates. The portable grill 10 is a self-contained, portable apparatus designed to hold charcoal briquettes on the lower grill grate 18 elevated off of the bottom of the base 14. The unit can be carried and moved indoors and outdoors without disturbing the charcoal or food that may be cooking on the upper grill grate 20.

FIG. 1 illustrates a side view of the preferred embodiment. The base 14 is attached to a plate 12 to provide stability from movement or placement on uneven surfaces. The stabilizer plate 12 is shaped as a saucer with a flat circular bottom. The bottom side of the plate 12 has a diameter larger than the lower end of the base 14. The diameter of the stabilizer plate 12 is large enough to give the base 14 stability to prevent tipping. In the preferred embodiment, this diameter is approximately six to seven inches, however this diameter is not a limiting design parameter. A portable grill of equivalent construction could have lessor or greater dimensions in all respects of the design. The side walls 24 of the plate 12 extend above the bottom 28 of the base up to a height adequate to maintain stability of the base 14. The stabilizer plate 12 of the preferred embodiment is a terra cotta size thirteen clay saucer. The plate 12 may be attached to the base 14 by any means that will withstand the elevated temperatures associated with charcoal grilling. In the preferred embodiment, the stabilizer plate 12 is attached to the base 14 with an adhesive.

The circular base 14 of the preferred embodiment is formed as a deep circular pot having a wall 26 at constant angle outward from the bottom 28 of the base less than ninety degrees, with a lip 30 in the wall between the rim 32 and bottom 28. The wall 26 is shaped as a truncated inverted cone that increases in diameter as the cone rises from the bottom 28. The lip 30 in the wall 26 steps up to a larger, constant diameter wall 34 above the lip 30. The constant diameter of the wall 34 above the lip 30 in the preferred embodiment is approximately 6.5 inches. The base 14 is closed at the bottom 28 and open at the rim 32. In a preferred embodiment, the base 14 may be a terra cotta size seventeen flowerpot that is modified to embody the claimed invention.

Referring to FIG. 1, slots 36 are cut through the base wall 26 near the bottom 28. The slots 36 function as air ventilation for ignited charcoal briquettes. The portable grill 10 is designed to hold a limited number of charcoal briquettes on top of the lower grill grate 18, depending on the size of the base 14. In the preferred embodiment, approximately five to ten briquettes are burned inside the base 14 while cooking food. Slots 36 are approximately 1 inch by ¾ inch in dimensions, with the slot's elongated axes parallel to the bottom 28. Four slots 36 are placed approximately one inch above bottom 28. Slot 36 location may vary depending on the location provided for the lower grill grate 18.

A first, lower grill grate 18 is removably installed inside the base 14. The lower grate 18 rests on four studs 38 installed in the wall. The studs 38 are installed through four 1/8th inch holes that are evenly disposed around the wall 26 at 1 and 1 1/2 inches from the bottom 28. Each stud 38 is inserted from the outside of the base 14. The studs 38 of the preferred embodiment are 8×32.5 brass bolts. Each stud 38 protrudes past the base wall 26 and are held onto the wall by nuts installed inside the wall 26. The first lower grill grate 18 inserts into the base 14 and rests on the top edge of each stud 18. The lower grate 18 holds charcoal briquettes above the bottom 28 and above the air ventilation slots 36. This configuration allows ashes from the briquettes to fall into the bottom of the pot where they are collected for subsequent disposal.

The preferred embodiment contains a second upper grill grate 20 inserted into the base 14 below the rim 20 and above the lower grate 18 to hold food above charcoal briquettes while cooking. An exemplary upper and lower grill grate 18, 20 of the preferred embodiment is illustrated in FIG. 3. The difference between the upper 20 and lower 18 grate would be a change in diameter. The grate 18, 20 is a series of circular metallic rings attached to rigid connector wires. In alternative embodiments, any combination of heat-absorbing, sturdy elements to create a grill or mesh having adequate open spaces between the elements will suffice. The second upper grill grate 20 is constructed of any material that has the rigidify to hold containers of food while resistant to breakdown or melting from a strong heat source.

The upper grill grate 20 inserts into the base 14 and rests on four upper studs 40 installed into the upper wall 34 of the base 14. The upper studs 40 are evenly disposed around the wall at approximately one-half inch down from the rim. Each upper stud 40 is inserted from the outside of the base 14. The upper studs 40 are 8×32.5 brass bolts. Each stud 40 protrudes past the upper wall 34 and are held onto the wall by nuts installed inside the wall 34. Alternatives for holding both the upper and lower grill grates 18, 20 in the base 14 include clips, adhesives, or any securing method that can withstand the elevated temperatures of the device.

The preferred embodiment is a compact, portable barbeque unit. A handle 16 is used to transport the grill 10. Two ends 42 of the handle are disposed into the wall 34 approximately 1/2 inch below the rim 32. The handle 16 is constructed of metallic copper or other alloy or plastic materials resilient enough and of sufficient strength to withstand the elevated temperatures and support the weight of a portable grill containing a full serving of food and charcoal. A single piece of bent wire forms the structure of the handle 16. The ends 42 of the bent wire are angled approximately ninety degrees from vertical such that the two ends face each another. Each angled end 42 is inserted through the upper wall 34. The top of the raised handle 16 is centered directly above the open face of the base 14. The handle 16 has an enlarged portion for ease of carrying and for insulation. The top of the handle passes through a hollow core of a hardwood dowel. The wire handle 16 is shaped such that the dowel 44 generally remains in the center of the handle 16. The handle 16 is rotatably affixed to the base 14 and may be lowered to the side of the grill 10 during use, or raised above the grill 10 while transported.

The lid 22 of the preferred embodiment is illustrated in FIG. 2. The lid 22 is a generally a dome-shaped cover that rests onto the base rim 32, thereby covering the open end of the base 14. The lid 22 comprises a handle 46 attached to the top of the lid 22. The lid handle 46 is mounted to the lid 22 with a screw from the inside of the lid. The top of the lid has a 1/8 hole that receives the handle screw from inside the lid protruding outside the lid. The screw is inserted through a washer inside the lid, through the lid, and into the handle through holes in the lid. The lid handle 46 is attached to the lid 22 with a metal ring and rivets 50. A series of vent holes 52 are placed near the top of the lid 22 around the circumference. The vent holes 52 in the preferred embodiment are approximately 3/16 in. diameter each. Inner, adjustable tabs 54 are also installed near the lid's rim 56. Four tabs 54 are evenly placed around the circumference of the rim 56. The adjustable tabs allow the lid 22 to fit securely into the base 14 of the grill 10. The lid 22 is constructed of terra cotta clay, however any material suitable to withstand the heat and flames generated by ignited charcoal and grilling food in the base is suitable for the lid.

Alternative embodiments of the portable grill comprise the same features as the preferred embodiment of a base, lower and upper grill grates, handle, and lid, however, the base, lid, grates, and base may be different designs, such as rectangular, inverted pyramid, and bowl-shaped. In additional, alternative embodiments are also constructed of metal, stone, or materials suitable for use for charcoal grilling.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

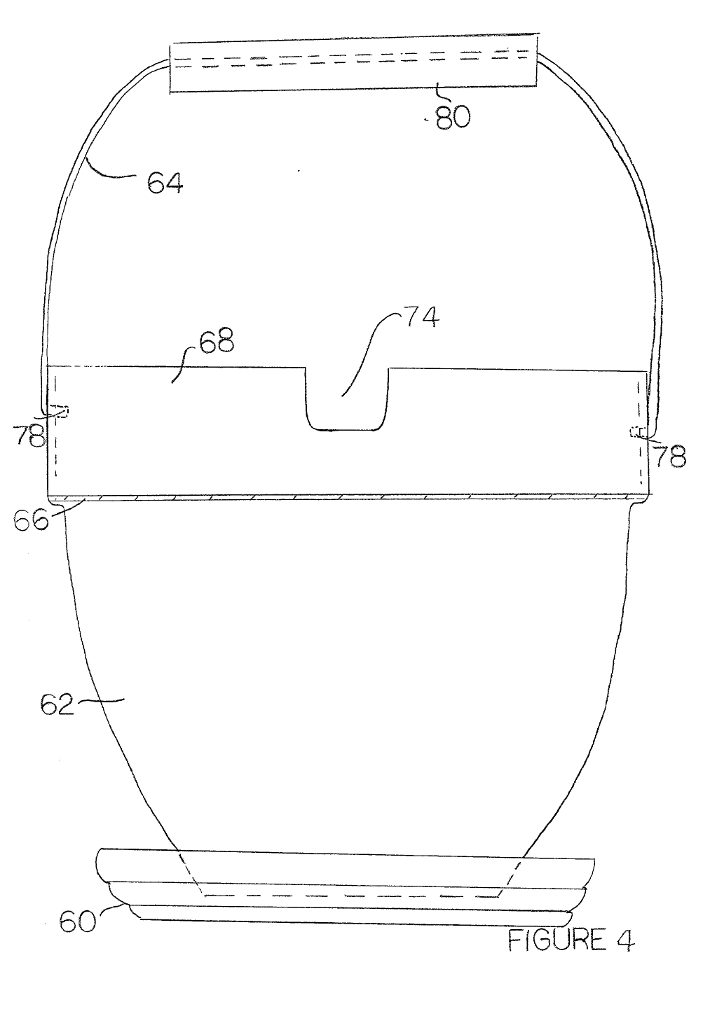

An alternative exemplary embodiment of a portable outdoor grill is illustrated in FIGS. 4 through 7. Referring to FIG. 4, the apparatus comprises a base 60, a lower grill section 62, a handle 64, a wire grill 66, and an upper grill section 68. The alternative embodiment is a self-contained, portable apparatus designed to contain a heating element within the lower section 62 that keeps food placed inside the lower section warm. FIG. 7 illustrates heating element 70 resting on the bottom of the lower grill section 62. The apparatus can be carried and moved indoors and outdoors without disturbing the heating element 70 or food resting on the grill surface 66. The grill is attached to a stable base 60 and is safe to be placed on tabletops, floors, and ground surfaces while in use.

FIG. 4 illustrates a side view of the lower grill section 62 of an alternative embodiment. The grill is attached to base, 60, however the grill may fully function without base 60. Base 60 is shaped as a shallow bowl with a flat circular bottom. The flat bottom side of base 60 has a diameter adequate to stabilize the lower grill section 62. The diameter of the base 60 is large enough to give the unit stability to prevent tipping. In an exemplary embodiment, this diameter is approximately six to seven inches. The side walls of the base extend above the lower end of the lower grill section 62 up to one inch or a height adequate to maintain stability of the base 60 and catch drippings or runoffs from the grill.

The lower grill section 62 of the alternative embodiment is formed as a deep pot having two forms of circular walls. The lower section of the circular wall 62 decreases in diameter until stopped at a flat bottom. The upper portion of the circular wall 68 is attached to the lower section 62 and has a consistent outer diameter slightly larger than the rim diameter of the lower portion 62. The upper section 68 overhangs the rim of lower section 62 by approximately one half inch around the section. The diameter of upper section 68 of the wall is approximately 6.5 inches in an exemplary embodiment.

Referring to additionally to FIG. 7, heating element 70 is attached to or resting upon the bottom of lower pot section 62. The heating element 70 is a candle or petroleum-based element. Alternative heating elements include a battery or electrically powered elements. Heating element 70 can be removably attached to the bottom of the pot section 62 for replacement or maintenance.

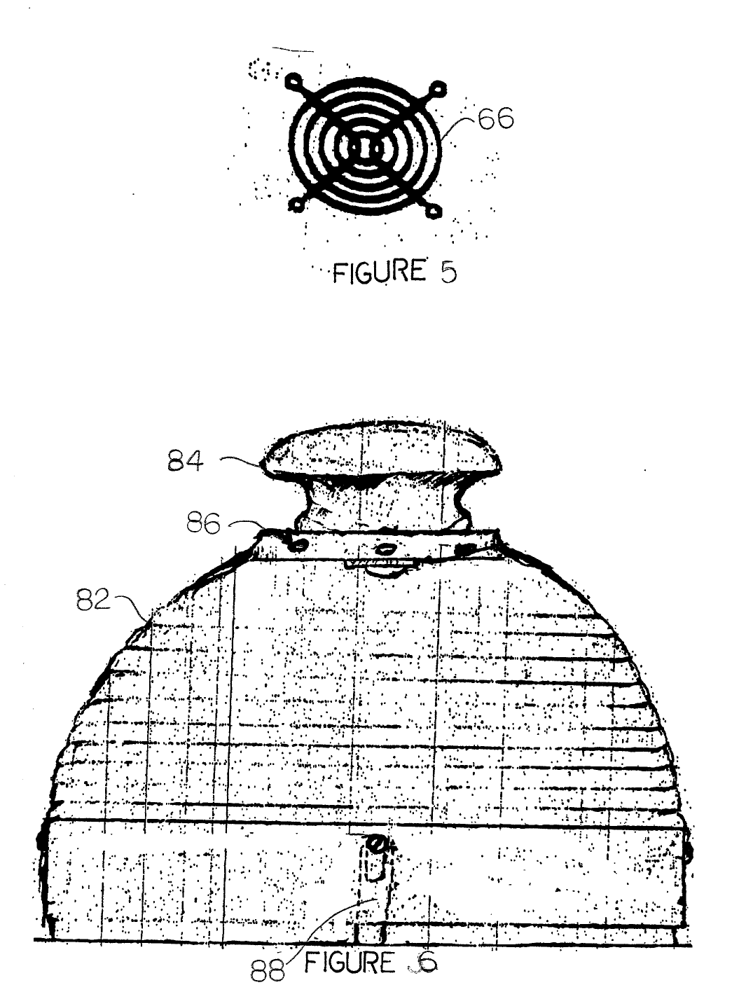

Referring additionally to FIG. 5 ,the alternative exemplary embodiment contains a wire grill or mesh element 66 placed below the rim of the upper section 68 and above the heating element 70. The wire mesh 66, in an exemplary embodiment is a series of circular metallic rings attached to two rigid connector pieces each bent in approximately ninety degree angles. In alternative embodiments, any combination of heat-resistant, sturdy elements to create a mesh, or a design having open spaces between the elements will suffice. The wire mesh 66 element is constructed of any material that has the rigidify to hold containers of food while and is resistant to breakdown or melting from a flaming heat source. The wire mesh 66 on the overhanging ledge created by the top portion 68 of the pot section.

The lower pot section 62 of the portable grill has two notches 74 cut into upper circular section 68. The notches 74 are positioned diametrically opposite one another. In an exemplary embodiment, the notches 74 are cut approximately one inch deep from the top rim of the upper section 68 and one inch wide at the top of the rim. The wire mesh 66 can a food container such as a large cup 72 (see FIG. 7) above heating element 70, allowing heat from the heating element 70 to rise through the grill element to contact a food container 72. A loop handle fits into notch 74 to prevent cup 72 from moving and to fit a large cup 72 with a handle onto wire mesh 66 with handle 76 getting caught on the upper rim of upper section 68.

The alternative exemplary embodiment is a portable unit. Handle 64 attaches on opposite sides of the circular wall of the upper pot section into holes 78. The handle 64 is constructed of metallic or other alloy or plastic materials resilient enough and of sufficient strength to withstand the weight of a portable grill unit containing a full serving of food. The preferred embodiment has two holes 78 on opposite sides of circular wall 68 near the top rim. A single piece of bent wire 64 forms the structure of the handle. The ends of the bent wire are angles approximately ninety degrees from vertical such that the two ends face one another. Each angled end is inserted through each hole 78. The top of the handle, standing directly above the open face of the pot section, passes through a hardwood dowel 80. The hardwood dowel 80 has a hollow core wherein the handle passes. The dowel 80 and wire handle 64 are loosely attached to each other such that the dowel 80 does not slide to one side of the handle and generally remains in the center of the handle 64. The handle 64 is rotatably affixed to the pot section and may be lowered to the side of the grill unit during use of the grill, or raised above the unit when the unit is transported.

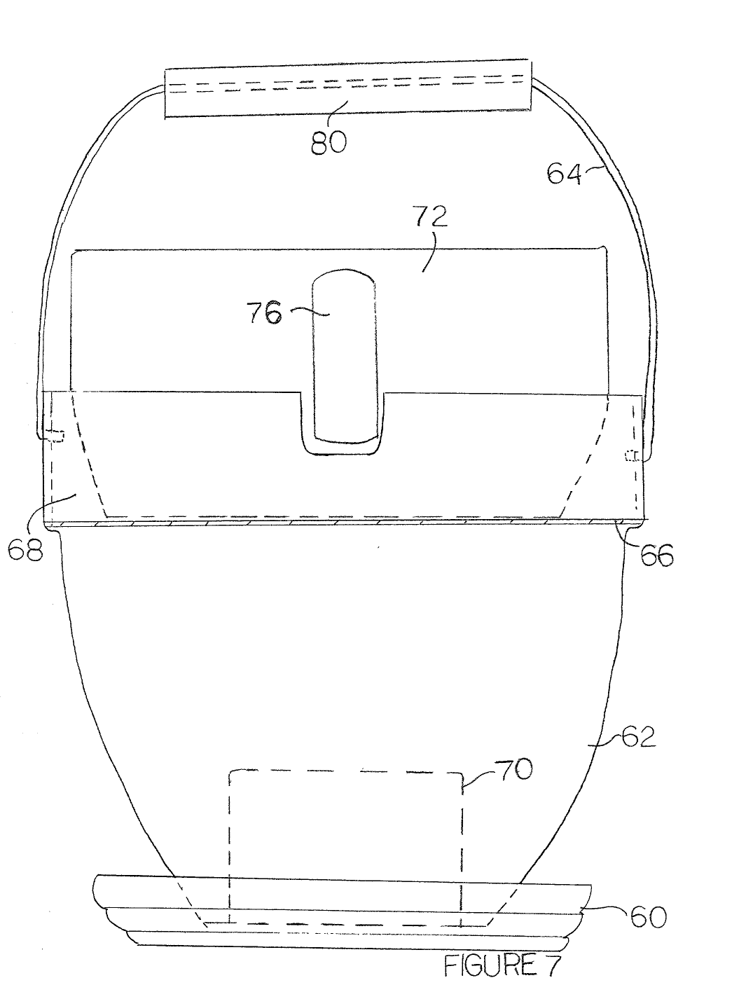

Referring to FIG. 6, lid 82 of the portable grill is illustrated. Lid 82 is a dome-shaped cover that fits onto the upper pot section 68. Lid 82 section comprises a handle 84 attached to the top of the lid 82 that is mounted with screws through holes in the lid. A series of vent holes 86 are placed near the top of lid 82 around the circumference. Vent holes 86 in the alternative exemplary embodiment are approximately 3/16 in. diameter. Adjustable tabs 88, are also installed inside the lid near the rim. Four tabs 88 are installed at zero, 90, 180, and 270 degrees around the circumference of the rim. The adjustable tabs 88 allow the lid to fit securely into the upper section 78 of the grill unit.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A portable grill apparatus, comprising:
a bowl-shaped member having circular wall with a closed bottom end and open top end;
a mesh grill resting inside said bowl-shaped member between said top end and said bottom end;
a handle for transporting said grill.

2. The apparatus of claim 1, wherein:
said grill is constructed of pottery materials.

3. The apparatus of claim 1, further comprising:
a lid formed to rest on said open end of said bowl-shaped member, said lid having a handle for removal and replacement.

4. The apparatus of claim 3, wherein:
said lid has holes for ventilation.

5. The apparatus of claim 1, wherein:
said handle comprises a metal wire having ends inserted into opposing sides of said member near said open end.

6. The apparatus of claim 1, further comprising:
a base attached to said closed end of said bowl-shaped member.

7. The base of claim 6, wherein:
said base is attached to the outside of said closed end of said bowl-shaped member, said base formed as a saucer receiving said closed end of said base into the recessed volume of said base.

8. The apparatus of claim 1, wherein:
said grill is constructed of terra cotta clay material.

9. A portable barbeque grill, comprising:
a bowl-shaped member having an open top end and a closed bottom end, said member having ventilation holes near said closed end;
a cooking mesh inserted into said member and resting above said closed end;
a lid formed to rest on said open end of said base having a handle for transportation
a handle for transporting said grill.

10. The apparatus of claim 9, further comprising
a second mesh inserted into said base and resting above said first mesh;

11. The portable barbeque grill of claim 6, wherein:
said base and said lid are constructed of clay materials.

12. The apparatus of claim 9, wherein:
said grill is constructed of pottery materials.

13. The apparatus of claim 9, further comprising:
a lid formed to rest on said open end of said bowl-shaped member, said lid having a handle for removal and replacement.

14. The apparatus of claim 13, wherein:
said lid has holes for ventilation.

15. The apparatus of claim 9, wherein:
said handle comprises a metal wire having ends inserted into opposing sides of said member near said open end.

16. The apparatus of claim 9, further comprising:
a base attached to said closed end of said bowl-shaped member.

17. The base of claim 16, wherein:
said base is attached to the outside of said closed end of said bowl-shaped member, said base formed as a saucer receiving said closed end of said base into the recessed volume of said base.

18. The apparatus of claim 9, wherein:
said grill is constructed of terra cotta clay material.
